(19) United States
(12) Patent Application Publication
(10) Pub. No.: US 2008/0083749 A1
(43) Pub. Date: Apr. 10, 2008

(54) METHOD AND APPARATUS FOR THE DEHYDRATION AND/OR STERILIZATION OF ORGANIC MATERIALS

(75) Inventors: Steve L. Kantor, Oshawa (CA); Douglas Norton, Whitby (CA)

Correspondence Address: DIMOCK STRATTON LLP, 20 QUEEN STREET WEST SUITE 3202, BOX 102, TORONTO, ON, M5H 3R3, US

(73) Assignee: ENVIRONMENTAL WASTE INTERNATIONAL, INC., Ajax (CA)

(21) Appl. No.: 11/468,538

(22) Filed: Aug. 30, 2006

(51) Int. Cl. H05B 6/64

(52) U.S. Cl. 219/679

(57) ABSTRACT

An apparatus and method for sterilizing and/or dehydrating organic materials. The apparatus comprises a microwave chamber, at least one microwave generator for irradiating material within the drum, and a vacuum system coupled to the microwave chamber to evacuate the microwave chamber to a desired pressure below atmospheric pressure. In one embodiment the microwave chamber contains a microwave-permeable rotatable drum having an access opening and a helical vane disposed along an inner wall of the drum, the vane being oriented so that when the drum is rotating in a loading direction the material is tossed and driven away from the access opening, and upon a reversal of the rotation of the drum to an unloading direction, the material is driven toward the access opening to be discharged from the drum.

### FIELD OF THE INVENTION

This invention relates to a method and apparatus for the sterilization and/or dehydration of organic materials.

### BACKGROUND OF THE INVENTION

There has long been and continues to be a need for an effective means of destroying, sterilizing or otherwise neutralizing organic material, for example waste material, from a variety of sources, in conditions where it is impractical or undesirable to move the waste off-site for treatment. Conventionally, the only on-site waste treatment which is economically viable has been by way of burning.

Burning wastes in an enclosed area may be dangerous. Moreover, as has become more evident in recent years, a wide variety of toxic gases can be given off in the burning of waste materials.

For example, military ships typically store, in designated areas, all food waste accumulated on the ship until the waste can be disposed of in a suitable manner. Due to the climate in some geographic regions, this waste must be stored in refrigerated areas. However, refrigerated area capacity can be limited, and thus waste often ends up also being stored on the deck, where it can be exposed to high (e.g. 40° C.) temperatures. Such high temperatures cause the waste to putrefy, creating obnoxious odours which can result in nausea among crew members, as well as unsanitary and unhygienic conditions aboard the ship.

While microwave treatment has been proposed as a method of dealing with such waste, systems have not been widely available which are secure against leakage, environmentally acceptable, and economically reasonable. For example, such waste treatment systems must be sealed against leakage at all steps of the process, to prevent not only against leaking of undesirable gases but also of microwave radiation. The systems must also be cost-and energy-efficient. Thus it is necessary to apply an appropriate amount of microwave energy, for a suitable time period, for the amount of waste being treated.

Moreover microwave treatment systems tend to be fragile and not robust enough to operate in naval military conditions. Nor are they sufficiently compact to pass through existing ship openings.

### BRIEF DESCRIPTION OF THE DRAWINGS

In drawings which illustrate by way of example only a preferred embodiment of the invention,

FIG. 1 is a perspective view of an apparatus of the present invention;

FIG. 2 is a process flow schematic of an embodiment of the present invention;

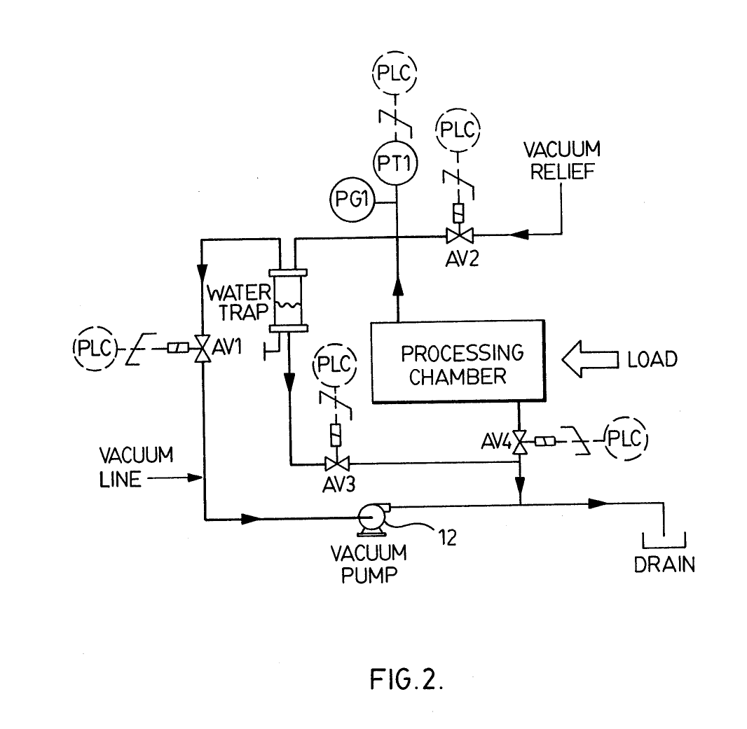

FIG. 3 is a perspective view of a further embodiment of an apparatus of the present invention.

### DETAILED DESCRIPTION OF THE INVENTION

The present invention provides a method and apparatus for the treatment of waste materials, using a microwave vacuum system to sterilize and/or dehydrate organic waste. The apparatus of the invention is robust and compact enough to be portable, and treats the waste to the desired state without emitting noxious or undesirable gases or chemical bi-products.

The invention provides a method for the sterilization or dehydration, or both, of organic material in an apparatus comprising a microwave chamber, comprising the steps of: a. transferring the material to a microwave chamber; b. evacuating the microwave chamber to a desired pressure; c. exposing the material to microwave energy; and d. venting water vapour from the microwave chamber.

The invention further provides an apparatus for dehydrating or sterilizing organic material, or both, comprising: a microwave chamber comprising a microwave generator, and a vacuum pump in communication with the microwave chamber, for evacuating the microwave chamber to a desired pressure below atmospheric pressure.

The invention further provides an apparatus for dehydrating or sterilizing organic material, or both, comprising a microwave chamber containing a microwave-permeable rotatable drum having an access opening and a helical vane disposed along an inner wall of the drum, the vane being oriented so that when the drum is rotating in a loading direction the material is tossed and driven away from a the access opening, and upon a reversal of the rotation of the drum to an unloading direction, the material is driven toward the access opening for discharge therefrom, at least one microwave generator for irradiating the material within the drum, and a vacuum system coupled to the microwave chamber to evacuate the microwave chamber to a desired pressure below atmospheric pressure.

The invention will be described and illustrated in the context of food waste that may accumulate in a self-contained environment such as a ship, however it will be appreciated that the principles of the invention can be applied to any type of organic material and in many environments and the invention is not intended to be limited to waste materials or to transportation vehicles or other specific spaces.

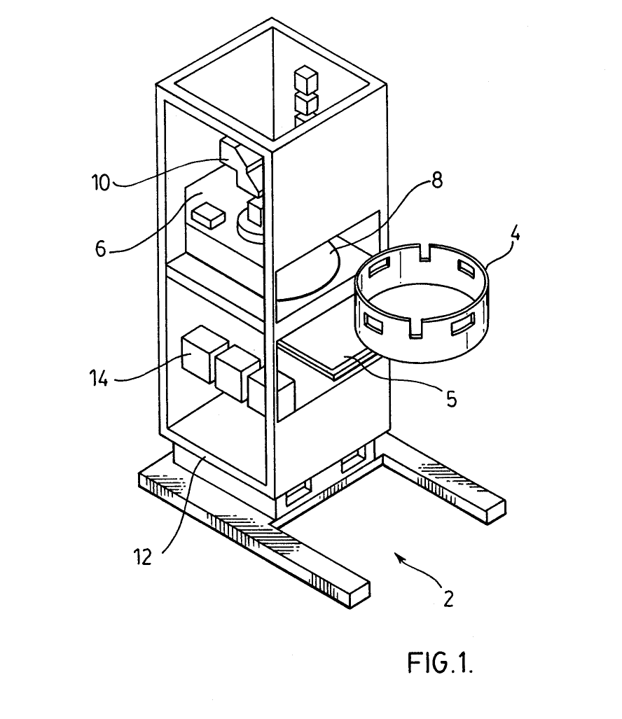

An apparatus according to one embodiment of the invention is illustrated schematically in FIG. 1. Organic waste (not shown) is collected and delivered to the waste sterilizer/dehydrator apparatus 2, shown in FIG. 1. The waste can be collected in either bags, boxes or other suitable containers. Once the waste has been collected, it can be placed in a waste receptacle, for example such as a portable fibreglass waste tray 4 that is permeable to microwaves. The tray 4 serves to contain any potential leakage from the waste, and will permit the manual transfer of the waste into the microwave chamber.

In one embodiment, the waste is transferred to the microwave chamber by hand, by loading the waste material to the receiving tray 4. Prior to loading the tray 4 the waste material may be surface-enhanced by surface area enhancement means such as a grinder or shredder (not shown), or any other device or process suitable for the purpose of decreasing the size of the waste particles and thereby increasing the exposed surface area of the waste, improving penetration of the microwaves (and facilitating tumbling in a further embodiment of the invention, described below).

The ground or shredded waste is fed from the outlet of the surface enhancing device (not shown) directly to the microwave chamber 6 in batches, for example 22 litres per batch in the case of the embodiment illustrated. The microwave chamber 6 is coupled to a vacuum system comprising a vacuum pump 12, for sterilizing and dehydrating the waste in a negative pressure environment, and contains a rotating turntable 8 for supporting and moving the waste material during treatment to improve the uniformity of microwave bombardment throughout the batch.

In one embodiment the invention uses one or more magnetrons 10 to generate microwaves at 2,450 MHz, powered by a power supply 14, disposed adjacent to the microwave chamber 6 for irradiating the contents of the chamber 6. Other frequencies may be used depending upon the target material. The number of magnetrons 10 can vary depending on the overall size of the apparatus 2 and the waste material intended to be treated.

In operation, the microwave chamber 6 is evacuated (for example, to 0.5 bar absolute) by a vacuum pump 12, which may be located in a lower section of the apparatus 2, and subjected to microwave energy (for example, up to 6 kW at 2.45 GHz) until the waste material has reached the desired temperature. As the magnetrons irradiate the chamber 6 the turntable 8 is rotated, for example at approximately 4 rpm, to facilitate even heating of the waste material. By heating up the waste material under low pressure conditions, significant amount of humidity removed from the waste material through evaporation, dehydrating the waste material.

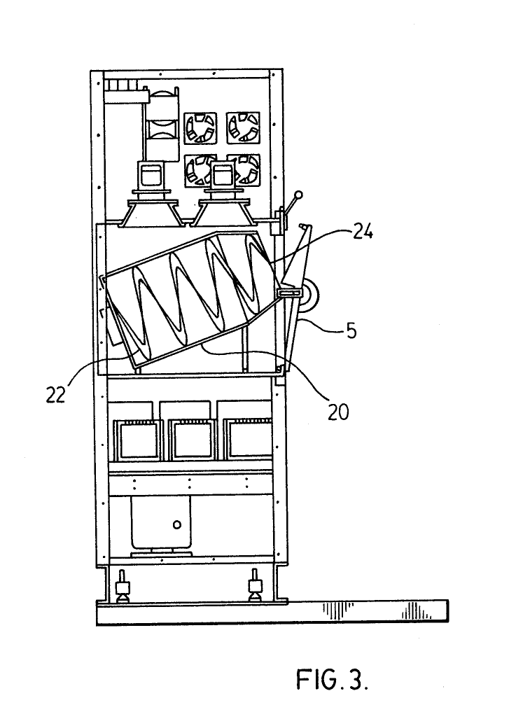

In a further embodiment of the invention, illustrated in FIG. 3, a drum 20 disposed in the microwave chamber 6 is provided with an internal helical or spiral vane 22, and the waste to be treated is loaded into the drum 20. The waste is agitated by tumbling as the drum 20 rotates about a longitudinal axis, preferably at about 4 rpm, for example driven by an electric motor. The drum 20 is micro-wave permeable (e.g. composed of fibreglass) and has an access opening 24. The spiral vane 22 is disposed along the inner wall of the drum 20, as shown in FIG. 3, from the access opening 24 to a lower region of the drum 20, and the drum 20 is mounted at an angle.

In the operation of the embodiment of FIG. 3, the drum 20 is rotated in a loading direction and waste material is fed into the access opening 24, either manually or by automated means (not shown). The vane 22 moves the waste material from the access opening 24 of the drum 20 toward the lower region of the drum 20, loading the batch of waste into the drum 20. When the batch has been loaded, the door 5 is closed. The magnetrons 10 are activated to dehydrate and sterilize the waste, and the drum 20 continues to be rotated in the loading direction, tossing the waste as it is irradiated. When the dehydration cycle is complete, the door 5 is opened and the rotation of the drum 20 is reversed to an unloading direction, such that vane 22 drives the treated waste material progressively toward the access opening 24 and discharges the treated waste from the apparatus 2, for example into a container (not shown).

Microwave radiation is measured as power density in milliwatts per square centimeter (mW/cm²). A typical permissible level of radiation leakage from a standard industrial microwave oven is 5 mW/cm². The power density of microwaves decreases rapidly with increasing distance from the source, in accordance with the inverse square rule, so that power density is inversely proportional to the square of the distance. Human exposure to high levels of microwaves can result in a significant amount of microwave energy being absorbed by the body. Just as in food, the microwave energy is transformed into heat in bodily tissues. Sensitive parts of the body, such as the eyes and brain, are more at risk, and prolonged exposure at high power levels can cause permanent damage to these organs. Therefore, the apparatus of the invention uses conventional microwave seals to seal each of the chambers from each other and from the exterior of the device when in use. Electrical interlocks may be used to prevent microwave generation if the microwave door 5 is opened is inadvertently opened during the operation of the device.

Water vapour and/or steam resulting from the dehydration process is drawn out of from the microwave chamber 6 by the vacuum pump 12. A water trap (not shown) may be mounted over the microwave chamber 6 to collect condensed water droplets from the steam flow. The water is then automatically drained through an exhaust pipe (not shown) after each cycle, and may be discharged to the existing sewage system on the ship. In a 22 litre batch using three magnetrons 10 at the frequency and power level indicated above, the dehydration cycle is typically completed after about 15 minutes for food as the target material. Sterilization occurs as a natural consequence of the microwave bombardment during the dehydration process.

The dehydrated waste is then removed from the apparatus and transported or placed in a storage container for ultimate disposal. A cooling down period of at least 5 minutes is preferred, as the processed organic waste can be very hot and thus there is a danger of scalding while handling the waste immediately following dehydration.

In a further embodiment, the temperature of the waste is monitored, and when the desired temperature has been reached so that the waste material has been sterilized and/or dehydrated and will not putrefy in hot temperatures, the waste material is then discharged by means of reversing the rotation of the drum 20 resulting in the direction of the spiral vane to progressively move the waste to the front edge, such as a discharge outlet, of the drum 20 and ultimately out of the drum 20 into a waiting container for storage and/or disposal.

The system is controlled by a PLC (Programmable Logic Controller) 16 that controls the input and discharge of the waste, and monitors temperature, pressure, humidity and magnetron performance.

Various embodiments of the present invention having been thus described in detail by way of example, it will be apparent to those skilled in the art that variations and modifications may be made without departing from the invention. The invention includes all such variations and modifications as fall within the scope of the appended claims.

What is claimed is:

1. A method for the sterilization or dehydration, or both, of organic material in an apparatus comprising a microwave chamber, comprising the steps of:
a. transferring the material to a microwave chamber;
b. evacuating the microwave chamber to a desired pressure;
c. exposing the material to microwave energy; and
d. venting water vapour from the microwave chamber.

2. The method of claim 1, comprising during step d. the step of
d(i). agitating the material.

3. The method of claim 1, comprising before step a. the step of grinding or shredding the material to increase a surface area of the material.

4. An apparatus for dehydrating or sterilizing organic material, or both, comprising:
a microwave chamber comprising a microwave generator, and
a vacuum pump in communication with the microwave chamber, for evacuating the microwave chamber to a desired pressure below atmospheric pressure.

5. The apparatus of claim 4 wherein the material is mounted within the microwave chamber on a turntable.

6. The apparatus of claim 4 wherein the material is organic waste.

7. The apparatus of claim 4 wherein the microwave generator comprises at least one magnetron assembly.

8. The apparatus of claim 4 comprising a temperature sensor for sensing a temperature of the waste during processing.

9. The apparatus of claim 8 comprising a controller for terminating the microwave generator when the waste has reached a preset temperature.

10. The apparatus of claim 9 wherein the preset temperature is preset based at least in part on a weight of the material.

11. An apparatus for dehydrating or sterilizing organic material, or both, comprising
a microwave chamber containing a microwave-permeable rotatable drum having an access opening and a helical vane disposed along an inner wall of the drum, the vane being oriented so that when the drum is rotating in a loading direction the material is tossed and driven away from a the access opening, and upon a reversal of the rotation of the drum to an unloading direction, the material is driven toward the access opening for discharge therefrom,
at least one microwave generator for irradiating the material within the drum, and
a vacuum system coupled to the microwave chamber to evacuate the microwave chamber to a desired pressure below atmospheric pressure.

12. The apparatus of claim 11 wherein the drum is mounted within the microwave chamber on an angle such that the access opening is elevated above an end of the drum.

13. The apparatus of claim 11 wherein the material is organic waste.

14. The apparatus of claim 11 wherein the microwave generator comprises at least one magnetron assembly.

15. The apparatus of claim 11 comprising a temperature sensor for sensing a temperature of the waste during processing.

16. The apparatus of claim 15 comprising a controller for terminating the microwave generator when the waste has reached a preset temperature.
